(19) United States
(12) Patent Application Publication
(10) Pub. No.: US 2025/0270747 A1
(43) Pub. Date: Aug. 28, 2025

(54) SPUNBONDED NONWOVEN LAMINATE AND METHOD OF MAKING SAME

(71) Applicant: REIFENHÄUSER GMBH & CO. KG MASCHINENFABRIK, Troisdorf (DE)

(72) Inventors: Patrick BOHL, Henner (DE); Andreas ROESNER, Bonn (DE); Tobias WAGNER, Koeln (DE)

(21) Appl. No.: 18/858,321

(22) PCT Filed: Jun. 16, 2023
(86) PCT No.: PCT/EP2023/066323

§ 371 Date: Oct. 21, 2024

(30) Foreign Application Priority Data
Jun. 17, 2022 (DE) 10 2022 115 200.6

(51) Int. Cl. D04H 3/018; B32B 5/02; B32B 5/26; D04H 3/007; D04H 3/02; D04H 3/12; D04H 3/16

(52) U.S. Cl. CPC D04H 3/018; B32B 5/022; B32B 5/267; D04H 3/007; D04H 3/02; D04H 3/12; D04H 3/16; B32B 2262/0253; B32B 2262/16; B32B 2307/516; D10B 2321/02; D10B 2401/062; D10B 2401/063

(57) ABSTRACT

A spunbonded nonwoven laminate comprising at least two spunbonded nonwoven layers made of continuous filaments, wherein at least one crimped spunbonded nonwoven layer comprising bulked continuous filaments is present. The bulked continuous filaments of the at least one crimped spunbonded nonwoven layer are multicomponent filaments comprising at least one first polymer component and at least one second polymer component. At least one reinforcing spunbonded nonwoven layer which consists or substantially consists of non-bulked continuous filaments and/or continuous filaments that are less bulked in comparison with the continuous filaments of the at least one crimped spunbonded nonwoven layer is present. The continuous filaments of the reinforcing spun-bonded nonwoven layer comprise at least one binder component arranged at their surface. The melting temperature difference between the binder component of the continuous filaments of the reinforcing spunbounded nonwoven layer and the first polymer component of the continuous filaments of the at least one crimped spunbounded nonwoven layer is less than 15° C. The laminate has a maximum cantilever flexural strength of at most 100 mm.

The invention relates to a spunbonded nonwoven laminate comprising at least two spunbonded nonwoven layers made of continuous filaments, wherein at least one crimped spunbonded nonwoven layer is provided that has crimped continuous filaments, in particular consists of or substantially consists of crimped continuous filaments, wherein the crimped continuous filaments of the at least one crimped spunbonded nonwoven layer are multicomponent filaments, in particular bicomponent filaments. The subject matter of the invention is furthermore a method of making a spunbonded nonwoven laminate comprising at least two spunbonded nonwoven layers made of continuous filaments. The continuous filaments of the at least two spunbonded nonwoven layers of the spunbonded nonwoven laminate according to the invention preferably comprise continuous filaments made of thermoplastic material. Continuous filaments differ due to their virtually endless length from short fibers that have significantly shorter lengths of for example 1 mm to 60 mm.

Spunbonded nonwoven laminates and methods of making spunbonded nonwoven laminates are basically known from practice in different embodiments. For spunbonded nonwovens or spunbonded nonwoven laminates a satisfactory drapability is usually required for later use, for example in the hygiene sector. However, spunbonded nonwoven laminates having good drapability are usually not very mechanically stable and are frequently unable to withstand in particular larger tensile forces acting on the spunbonded nonwoven laminates to a sufficient degree. This is disadvantageous and therefore it is also desirable for spunbonded nonwoven laminates to be mechanically stable and, in particular, to have sufficient longitudinal stiffness, which also ensures the machinability of the spunbonded nonwoven laminates. In this respect, there is a conflict of objectives for the spunbonded nonwoven laminates known from practice between satisfactory drapability and sufficient mechanical stability, in particular sufficient longitudinal stiffness. In this context, it is known to provide multilayer spunbonded nonwoven laminates whose individual layers have different properties, for example with regard to softness and strength, so that different target parameters of the spunbonded nonwoven laminates can be adjusted by the properties of the individual layers. Such spunbonded nonwoven laminates have generally proven to be successful. However, with these measures known from practice it has been shown that the abrasion resistance of the spunbonded nonwoven laminates often leaves much to be desired. In particular, undesirable delamination processes were observed in the known spunbonded nonwoven laminates. In addition, an optimal compromise between the drapability and the mechanical stability of the spunbonded nonwoven laminates has not yet been achieved. There is a need for improvement in this respect. This is where the invention comes in.

The object of the invention is to provide a spunbonded nonwoven laminate of the above-mentioned type in which an optimal compromise between a satisfactory drapability and a sufficient mechanical stability, in particular an advantageous longitudinal stiffness, is achieved and in which undesirable delamination processes can nevertheless be avoided and that in this respect is preferably also characterized by an advantageous abrasion resistance. The invention is further based on the technical problem of providing a method of making such a spunbonded nonwoven laminate.

To attain this object, the invention teaches a spunbonded nonwoven laminate comprising at least two spunbonded nonwoven layers made of continuous filaments, wherein at least one crimped spunbonded nonwoven layer is provided that has crimped continuous filaments, in particular consists of or substantially consists of crimped continuous filaments, wherein the crimped continuous filaments of the at least one crimped spunbonded nonwoven layer are multicomponent filaments, in particular bicomponent filaments that comprise at least one first, preferably low-melting, plastic component and at least one second, preferably higher-melting, plastic component,
wherein at least one reinforcing spunbonded nonwoven layer is provided that consists or substantially consists of noncrimped continuous filaments and/or of continuous filaments that are less crimped compared to the continuous filaments of the at least one crimped spunbonded nonwoven layer, wherein the continuous filaments of the reinforcing spunbonded nonwoven layer comprise at least one binder component on their surface,
wherein the melting temperature difference between the binder component of the continuous filaments of the reinforcing spunbonded nonwoven layer and the first, preferably low-melting, plastic component of the continuous filaments of the at least one crimped spunbonded nonwoven layer is less than 15° C., preferably less than 12° C., preferably less than 8° C., particularly preferably less than 5° C., very preferably less than 3° C., quite particularly preferably less than 2° C., for example 0° C. or about 0° C., and
wherein the laminate has a maximum flexural stiffness with a cantilever of at most 100 mm, preferably of at most 90 mm, preferably of at most 80 mm, particularly preferably of at most 75 mm and quite particularly preferably of at most 70 mm.

According to a very preferred embodiment, the laminate according to the invention has a maximum flexural stiffness with a cantilever of at most 65 mm, preferably of at most 55 mm, particularly preferably of at most 50 mm, quite particularly preferably of at most 45 mm. When cantilever is mentioned here and hereinafter, this preferably means the cantilever in the MD direction and/or in the CD direction of the spunbonded nonwoven laminate, preferably at least the cantilever in the MD direction of the spunbonded nonwoven laminate. In the context of the invention, “machine direction” or “(MD)” means in particular the travel direction F of the spunbonded nonwoven laminate on a receiving device. In contrast, “CD or CD direction” means the direction transverse to the machine direction.

The flexural stiffness of the spunbonded nonwoven laminate is determined within the scope of the invention in particular according to the method “WSP 90.1 (05) Standard Test Method for Stiffness of Nonwoven: Fabrics Using the Cantilever Test.” Within the scope of the invention, a distinction is also made between the flexural stiffness on the one hand and the longitudinal stiffness of the spunbonded nonwoven laminate on the other hand. The flexural stiffness is in particular a measure of the drapability of the spunbonded nonwoven laminate, whereas the longitudinal stiffness is in particular a measure for the mechanical stability and preferably the machinability of the spunbonded nonwoven laminate. In the context of the invention, “longitudinal stiffness” means in particular the stiffness of the spunbonded nonwoven laminate in the machine direction (MD).

In the context of the invention, the expression “spunbonded nonwoven laminate” means in particular a nonwoven fabric that is a laminate with at least two spunbonded nonwoven layers. Here and subsequently, the term laminate is simply used instead of the term spunbonded nonwoven laminate. “Laminate” or “spunbonded nonwoven laminate” also means in particular the finished, preferably preconsolidated and/or finally consolidated, laminate.

It is recommended that continuous filaments with natural crimping or with a latent tendency to crimping are used as continuous filaments for the at least one crimped spunbonded nonwoven layer. Preferably, the at least one crimped spunbonded nonwoven layer comprises at least 90% by weight, preferably at least 95% by weight, quite particularly preferably at least 98% by weight of crimped continuous filaments. Quite particularly preferably, the at least one crimped spunbonded nonwoven layer consists of crimped continuous filaments or substantially consists of crimped continuous filaments. The natural crimping or latent tendency to crimping is conveniently induced by the choice of raw materials and/or process settings. Preferably, to this end at least one first low-melting plastic component and at least one (in comparison) second higher-melting plastic component are used for the continuous filaments of the at least one crimped spunbonded nonwoven layer. In the context of the invention, higher melting and low melting refers in particular to the melting temperature of the plastic components. In principle, however, the first and the second plastic component of the continuous filaments of the at least one crimped spunbonded nonwoven layer can also have the same melting temperature and then a crimping or tendency to crimping can also be realized by other different properties of the plastic components.

According to the invention, the at least one reinforcing spunbonded nonwoven layer consists of or substantially consists of noncrimped continuous filaments and/or of continuous filaments that are less crimped compared to the continuous filaments of the at least one crimped spunbonded nonwoven layer. Within the scope of the invention, the at least one reinforcing spunbonded nonwoven layer is responsible in particular for the mechanical stability or the longitudinal stiffness of the spunbonded nonwoven laminate and the configuration of the continuous filaments of the at least one reinforcing spunbonded nonwoven layer preferably also contributes to an advantageous abrasion resistance and to the prevention of delamination processes in the spunbonded nonwoven laminate according to the invention. The fact that the continuous filaments of the at least one reinforcing spunbonded nonwoven layer consist or substantially consist of continuous filaments that are less crimped compared to the continuous filaments of the at least one crimped spunbonded nonwoven layer means in particular within the scope of the invention that the degree of crimping of the continuous filaments of the at least one reinforcing spunbonded nonwoven layer is lower than the degree of crimping of the continuous filaments of the at least one crimped spunbonded nonwoven layer.

The fact that the degree of crimping of the continuous filaments of one spunbonded nonwoven layer is lower than the degree of crimping of the continuous filaments of another spunbonded nonwoven layer means in particular that the continuous filaments have less crimping or less arcs per centimeter of filament length (number of arcs) and/or a larger crimping diameter or arc diameter than the continuous filaments of the other spunbonded nonwoven layer. The number of crimping loops or crimping arcs per centimeter of filament length are measured in particular according to the Japanese standard JIS L-1015-1981 by counting the crimping under a pretension of 2 mg/den in ( 1/10 mm), wherein the length of the crimped filaments under pretension is taken as the basis. A sensitivity of 0.05 mm is used to determine the number of loops or the number of crimping arcs. The measurement is conveniently carried out using a “Favimat” device from TexTechno, Germany. For this purpose, reference is made to the publication “Automatic Crimp Measurement on Staple Fibers,” Denkendorf Colloquium, Textile Mess-und Prüftechnik”, 9.11.99, Dr. Ulrich Mörschel (especially page 4, FIG. 4). For this purpose, the filaments (or the filament sample) are/is removed from the receiving device of belt as filament balls before further consolidation and the filaments are separated and measured.

The arc diameter is conveniently measured by placing the nonwoven fabric to be measured under a microscope and, using an appropriate magnification, creating a fixed image and the arc diameter can be measured therein. For nonwoven aggregates or nonwoven laminates comprising multiple plies or layers, the optical system must be focused on the surface of each visible ply or layer so that the other surfaces or plies or layers should be as far outside the depth of field as possible. Due to the random distribution of the filaments or the random distribution of the arc diameters, at least 25 measurements are required. The arithmetic mean is given.

According to the invention, the continuous filaments of the at least one reinforcing spunbonded nonwoven layer have at least one, in particular one or only one, binder component on their surface. According to the invention, the continuous filaments of the at least one crimped spunbonded nonwoven layer comprise at least one first, preferably low-melting, plastic component. Within the scope of the invention, a connection is expediently realized between the at least one reinforcing spunbonded nonwoven layer and the at least one crimped spunbonded nonwoven layer and in particular between the binder component of the continuous filaments of the reinforcing spunbonded nonwoven layer and at least the first, preferably low-melting, plastic component of the at least one crimped spunbonded nonwoven layer. This can be achieved in particular by consolidation measures or by the influence of pressure and/or temperature.

The melting temperature difference between the binder component of the continuous filaments of the reinforcing spunbonded nonwoven layer and the first, preferably low-melting component of the continuous filaments of the at least one crimped spunbonded nonwoven layer is less than 15° C. according to the invention. The melting temperature of the components of the continuous filaments, in particular of the used materials or plastics, is measured within the scope of the invention by dynamic differential scanning calorimetry (DSC) according to ISO 11357-3:2011. If the melting temperature difference between the binder component of the continuous filaments of the reinforcing spunbonded nonwoven layer and the first, preferably low-melting, component of the continuous filaments of the crimped spunbonded nonwoven layer according to a preferred embodiment is 0° C. or approximately 0° C., this means in particular that the two components have the same melting temperature or substantially the same melting temperature. This can be achieved by two different components or materials that have the same melting temperature or also whereby the material of the first, preferably low-melting, plastic component of the continuous filaments of the at least one crimped spunbonded nonwoven layer corresponds to the material of the binder component of the continuous filaments of the reinforcing spunbonded nonwoven layer. According to a preferred embodiment, the binder component of the continuous filaments of the reinforcing spunbonded nonwoven layer corresponds to the first, preferably low-melting, plastic component of the continuous filaments of the at least one crimped spunbonded nonwoven layer with regard to the used material or plastic. It is within the scope of the invention that the melting temperature of the binder component of the continuous filaments of the reinforcing spunbonded nonwoven layer is higher or lower than the melting temperature of the first, preferably low-melting, plastic component of the continuous filaments of the at least one crimped spunbonded nonwoven layer.

The spunbonded nonwoven laminate according to the invention is characterized by a satisfactory drapability, in particular due to the advantageously low flexural stiffness, and nevertheless has a sufficient mechanical stability, in particular a sufficient longitudinal stiffness. In addition, the delamination processes frequently observed in practice can be avoided with the spunbonded nonwoven laminate according to the invention, so that the laminate in particular has a very advantageous abrasion resistance. Through the special choice of components or plastic components of the at least one crimped spunbonded nonwoven layer and the at least one reinforcing spunbonded nonwoven layer the binding properties between the individual spunbonded nonwoven layers of the spunbonded nonwoven laminate are improved so that delamination processes can be significantly reduced.

A preferred embodiment of the spunbonded nonwoven laminate according to the invention is characterized in that the continuous filaments of the at least one reinforcing spunbonded nonwoven layer are monocomponent filaments that consist or substantially consist of the binder component. The fact that the continuous filaments or monocomponent filaments consist of or substantially consist of the binder component means in the context of the invention in particular that the continuous filaments of the at least one reinforcing spunbonded nonwoven layer only comprise the binder component and quite particularly preferably only comprise a (first) plastic as a binder component or consist of or substantially consist of only a (first) plastic. This will be explained in more detail below.

According to an alternative preferred embodiment of the spunbonded nonwoven laminate according to the invention, the continuous filaments of the at least one reinforcing spunbonded nonwoven layer are multicomponent filaments, in particular bicomponent filaments, preferably multicomponent filaments or bicomponent filaments with core-sheath configuration, particularly preferably multicomponent filaments or bicomponent filaments with centric or symmetrical core-sheath configuration and/or with eccentric core-sheath configuration and quite particularly preferably the at least one binder component of the continuous filaments of the reinforcing spunbonded nonwoven layer forms the sheath component of the continuous filaments with a core-sheath configuration. It is also within the scope of the invention that the continuous filaments of the at least one reinforcing spunbonded nonwoven layer formed as multicomponent filaments or bicomponent filaments have a different symmetrical cross-sectional configuration, for example a trilobal configuration or a mono-type configuration and the like. The fact that the at least one binder component is provided according to the invention on the surface of the continuous filaments of the reinforcing spunbonded nonwoven layer means in particular that the binder component is provided at least on the surface of these continuous filaments, such as in the case of the monocomponent filaments described above or in the case of the filaments with a core-sheath configuration described above, in which the binder component preferably forms the sheath component.

If the continuous filaments of the at least one reinforcing spunbonded nonwoven layer are multicomponent filaments or as bicomponent filaments with core-sheath configuration, it is within the scope of the invention that the core-to-sheath mass ratio of the continuous filaments of the reinforcing spunbonded nonwoven layer with a core-sheath configuration is 50:50 to 95:5, preferably 55:45 to 85:15, preferably 60:40 to 80:20. This embodiment is based in particular on the discovery that with these mass ratios a particularly good compromise can be achieved between the longitudinal stiffness of the resulting spunbonded nonwoven laminate and the abrasion resistance or the avoidance of delamination processes.

A particularly recommended embodiment of the spunbonded nonwoven laminate according to the invention is characterized in that the melting temperature of the binder component of the continuous filaments of the reinforcing spunbonded nonwoven layer is lower than the melting temperature of the second, preferably higher-melting, plastic component of the continuous filaments of the at least one crimped spunbonded nonwoven layer and wherein the melting temperature difference between the second, preferably higher-melting, plastic component of the continuous filaments of the at least one crimped spunbonded nonwoven layer and the binder component of the continuous filaments of the at least one reinforcing spunbonded nonwoven layer is preferably at least 2° C., preferably at least 5° C., particularly preferably at least 7° C.

In the event that the first and the second plastic component of the continuous filaments of the at least one crimped spunbonded nonwoven layer have the same melting temperature, this melting temperature is expediently used as the basis for determining the melting temperature difference between the second plastic component of the continuous filaments of the at least one crimped spunbonded nonwoven layer and the binder component of the continuous filaments of the at least one reinforcing spunbonded nonwoven layer. This preferred embodiment, in which the melting temperature of the binder component of the continuous filaments of the reinforcing spunbonded nonwoven layer is lower than the melting temperature of the second, preferably higher-melting, plastic component of the continuous filaments of the at least one crimped spunbonded nonwoven layer, is based on the discovery that the continuous filaments of the reinforcing spunbonded nonwoven layer then have very good binding properties compared to the continuous filaments of the at least one crimped spunbonded nonwoven layer. Delamination between the reinforcing spunbonded nonwoven layer and the at least one crimped spunbonded nonwoven layer can be further reduced in this way and in this respect the resulting spunbonded nonwoven laminate also exhibits very satisfactory abrasion resistance.

A particularly preferred embodiment of the spunbonded nonwoven laminate according to the invention is characterized in that the continuous filaments of the at least one reinforcing spunbonded nonwoven layer are more strongly oriented in the machine direction (MD) than the continuous filaments of the at least one crimped spunbonded nonwoven layer. This embodiment is based in particular on the discovery that the at least one reinforcing spunbonded nonwoven layer then has a particularly advantageous longitudinal stiffness. Preferably, the at least one reinforcing spunbonded nonwoven layer has a higher longitudinal stiffness than the at least one crimped spunbonded nonwoven layer. The orientation of the continuous filaments of the reinforcing spunbonded nonwoven layer and/or the continuous filaments of the at least one crimped spunbonded nonwoven layer in the machine direction (MD) can be determined within the scope of the invention in particular by microcomputer tomography (μCT), preferably as described in WO 2020/103964 A1, in particular on pages 50 to 53, “Method to determine geometric fiber statistics for a nonwoven.”

It is very preferred that the titre of the continuous filaments of the at least one reinforcing spunbonded nonwoven layer is less than 2.5 den, in particular less than 1.7 den, preferably less than 1.5 den, preferably 1.0 den to 1.4 den, particularly preferably 1.2 den to 1.4 den and/or that the titre of the continuous filaments of the at least one crimped spunbonded nonwoven layer is less than 3.0 den, preferably less than 2.0 den, preferably less than 1.7 den, particularly preferably 1.0 den to 1.6 den, quite particularly preferably 1.2 den to 1.4 den. It is within the scope of the invention that the titre of the continuous filaments of the at least one reinforcing spunbonded nonwoven layer is lower than the titre of the continuous filaments of the at least one crimped spunbonded nonwoven layer.

It is preferred that the at least one binder component of the continuous filaments of the reinforcing spunbonded nonwoven layer comprises a first plastic, in particular consists of or substantially consists of a first plastic, wherein the first plastic is preferably a homo-polyolefin, in particular a homo-polypropylene and/or a homo-polyethylene, and/or a polyolefin copolymer, in particular a polypropylene copolymer and/or a polyethylene copolymer. If the first plastic is a homo-polypropylene, it is within the scope of the invention that it is a polypropylene polymerized by metallocene catalysis. If the first plastic is a polypropylene copolymer, it is preferred that it is a propylene-a-olefin copolymer. It is particularly preferred that the first plastic is a polypropylene copolymer and/or a homo-polypropylene, in particular a homo-polypropylene polymerized by metallocene catalysis. When, in the context of the invention, it is said that a component consists of or substantially consists of a plastic, “substantially consists” means in particular that the component consists of at least 90% by weight, preferably at least 95% by weight and preferably at least 98% by weight of the plastic and takes into account in particular the fact that in addition to the said plastic, additives such as plasticizers, fillers, dyes, lubricants and the like can also be present to a small extent.

A further preferred embodiment of the invention is characterized in that the at least one binder component of the reinforcing spunbonded nonwoven layer consists or substantially consists of a mixture or a blend of at least one first plastic and at least one second plastic, and wherein preferably the first plastic and/or the second plastic is a homo-polyolefin, in particular a homo-polypropylene and/or a homo-polyethylene, and/or a polyolefin copolymer, in particular a polypropylene copolymer and/or a polyethylene copolymer. If the first plastic and/or the second plastic is a homo-polypropylene, it is within the scope of the invention that it is a polypropylene polymerized by metallocene catalysis. If the first plastic and/or the second plastic is a polypropylene copolymer, it is preferred that it is a propylene-a-olefin copolymer.

According to a preferred embodiment of the spunbonded nonwoven laminate according to the invention, the continuous filaments of the at least one reinforcing spunbonded nonwoven layer are bicomponent filaments with core-sheath configuration, wherein the at least one, in particular the one, binder component of the continuous filaments of the reinforcing spunbonded nonwoven layer expediently forms the sheath component of these continuous filaments with core-sheath configuration. The binder component forming the sheath component then expediently consists of at least one first plastic or of a mixture or blend of at least one first plastic and at least one second plastic, or substantially consists thereof, in accordance with the above information.

A preferred embodiment of the invention is characterized in that the core component of the continuous filaments with core-sheath configuration of the at least one reinforcing spunbonded nonwoven layer is at least one homo-polyolefin, in particular at least one homo-polypropylene and/or at least one homo-polyethylene, and/or at least one polyolefin copolymer, in particular at least one polypropylene copolymer and/or at least one polyethylene copolymer. If the core component of the continuous filaments with core-sheath configuration of the at least one reinforcing spunbonded nonwoven layer is at least one homo-polypropylene, it is within the scope of the invention that it is a polypropylene polymerized by metallocene catalysis or by Ziegler-Natta catalysis. If the core component of the continuous filaments with core-sheath configuration of the reinforcing spunbonded nonwoven layer is a polypropylene copolymer, it is preferred that it is a propylene-α-olefin copolymer. It is also preferred that the core component of the continuous filaments with core-sheath configuration of the reinforcing spunbonded nonwoven layer consists or substantially consists of only one plastic and then the plastic is expediently one of the plastics specified above. However, it is also possible in principle that the core component of the continuous filaments with core-sheath configuration of the reinforcing spunbonded nonwoven layer is a mixture or blend of at least two plastics. It is quite particularly preferred that the core component of the continuous filaments with core-sheath configuration of the reinforcing spunbonded nonwoven layer is at least one homo-polypropylene, in particular consists of or substantially consists of at least one homo-polypropylene. The homo-polypropylene is preferably a polypropylene polymerized by metallocene catalysis or by Ziegler-Natta catalysis. It is within the scope of the invention that both the core and the sheath of the continuous filaments with core-sheath configuration of the at least one reinforcing spunbonded nonwoven layer consist or substantially consist of a polyolefin copolymer, in particular of a polypropylene copolymer. Then the copolymer used in the sheath preferably has a higher comonomer fraction than the copolymer used in the core.

A particularly preferred embodiment of the spunbonded nonwoven laminate according to the invention is characterized in that the first, preferably low-melting, and/or the second, preferably higher-melting, plastic component of the continuous filaments of the at least one crimped spunbonded nonwoven layer is at least one homo-polyolefin, in particular at least one homo-polypropylene and/or at least one homo-polyethylene, and/or at least one polyolefin copolymer, in particular at least one polypropylene copolymer and/or at least one polyethylene copolymer. It is preferred that the first, preferably low-melting, plastic component of the continuous filaments of the at least one crimped spunbonded nonwoven layer and/or the second, preferably higher-melting, plastic component of the continuous filaments of the at least one crimped spunbonded nonwoven layer each consist or substantially consist of at least one plastic, in particular of only one plastic, and that this plastic is one of the plastics specified above. In principle, however, it is also within the scope of the invention that the first, preferably low-melting, plastic component of the continuous filaments of the at least one crimped spunbonded nonwoven layer and/or the second, preferably higher-melting, plastic component of the continuous filaments of the at least one crimped spunbonded nonwoven layer are present as a mixture or blend of at least two plastics. If the first and/or the second plastic component of the continuous filaments of the at least one crimped spunbonded nonwoven layer is at least one polypropylene copolymer, it is preferred that it is at least one propylene-α-olefin copolymer. If the first and/or the second plastic component of the continuous filaments of the at least one crimped spunbonded nonwoven layer is at least one homo-polypropylene, it is within the scope of the invention that this is at least one polypropylene polymerized by Ziegler-Natta catalysis.

A particularly preferred embodiment of the invention is characterized in that the binder component of the continuous filaments of the reinforcing spunbonded nonwoven layer and/or the first, preferably low-melting, plastic component of the continuous filaments of the at least one crimped spunbonded nonwoven layer and/or the second, preferably higher-melting, plastic component of the continuous filaments of the at least one crimped spunbonded nonwoven layer are each formed on the basis of a polyolefin from the same polyolefin material group, in particular based on polypropylenes. If the continuous filaments of the at least one reinforcing spunbonded nonwoven layer according to a particularly preferred embodiment of the invention are multicomponent filaments or as bicomponent filaments with core-sheath configuration, in which the binder component forms the sheath component, it is particularly preferred that the core component of the continuous filaments with core-sheath configuration of the reinforcing spunbonded nonwoven layer is also formed on the basis of a polyolefin from the same polyolefin material group as the binder component, the first and the second plastic component. In the context of the invention, “the same polyolefin material group” means in particular polyolefins that are based on the same olefin monomer, so that, for example, homo-polypropylenes and polypropylene copolymers belong to the same polyolefin material group, namely based on propylene.

It is within the scope of the invention that the continuous filaments of the at least one crimped spunbonded nonwoven layer are multicomponent filaments, in particular bi-component filaments, with side-by-side configuration and/or with core-sheath configuration, preferably with eccentric core-sheath configuration, and wherein preferably in the case of a core-sheath configuration or eccentric core-sheath configuration, the first, preferably low-melting, plastic component of the continuous filaments of the at least one crimped spunbonded nonwoven layer forms the sheath component. Then, the second, preferably higher-melting, plastic component of the continuous filaments of the at least one crimped spunbonded nonwoven layer preferably forms the core component. In the case of continuous filaments with side-by-side configuration, the first and second plastic components preferably each form one side of the filaments. In the context of the invention, the expression configuration of continuous filaments refers in particular to the cross-sectional configuration of the filaments.

It is quite particularly preferred that the first, preferably low-melting, plastic component of the continuous filaments of the at least one crimped spunbonded nonwoven layer is a polypropylene copolymer and in particular consists or substantially consists of a polypropylene copolymer. It is within the scope of the invention that this is the same polypropylene copolymer that preferably forms the first plastic of the binder component of the continuous filaments of the reinforcing spunbonded nonwoven layer. It is further preferred that the second, preferably higher-melting, plastic component of the continuous filaments of the at least one crimped spunbonded nonwoven layer is at least a homo-polypropylene and in particular consists or substantially consists of a homo-polypropylene. The homo-polypropylene is preferably a polypropylene polymerized by Ziegler-Natta catalysis. According to one embodiment, the homo-polypropylene of the second, preferably higher-melting, plastic component of the at least one crimped spunbonded nonwoven layer and the homo-polypropylene that is preferably used for the core component of the continuous filaments with core-sheath configuration of the reinforcing spunbonded nonwoven layer are the same or a different homo-polypropylene.

If the continuous filaments of the at least one crimped spunbonded nonwoven layer are multicomponent filaments, in particular bicomponent filaments, with eccentric core-sheath configuration, it is within the scope of the invention that both the sheath of the filaments and also the core of the filaments seen in the filament cross-section are circular. According to a further preferred embodiment of the invention, the multicomponent filaments or bicomponent filaments are formed as multicomponent filaments or bicomponent filaments with eccentric core-sheath configuration and the core of these filaments is seen in the filament cross-section, configured to be circular segment-shaped and has a circular arc-shaped circumferential section as well as a linear circumferential section with respect to its circumference, so that a D-shape of the core seen in the filament cross-section results. The above statements with regard to the cross-sectional design of continuous filaments with eccentric core-sheath configuration also apply to the embodiment of the spunbonded nonwoven laminate according to the invention, in which the continuous filaments of the at least one reinforcing spunbonded nonwoven layer are multicomponent filaments, in particular as bicomponent filaments, with eccentric core-sheath configuration.

It has proven useful that the mass ratio of the first, preferably low-melting, plastic component of the continuous filaments of the at least one crimped spunbonded nonwoven layer to the second, preferably higher-melting, plastic component of the at least one crimped spunbonded nonwoven layer is 10:90 to 60:40, preferably 25:75 to 50:50, preferably 30:70 to 40:60.

A particularly preferred embodiment of the spunbonded nonwoven laminate according to the invention is characterized in that at least one second crimped spunbonded nonwoven layer is provided and wherein the at least one reinforcing spunbonded nonwoven layer is preferably between the at least two crimped spunbonded nonwoven layers, in particular between the two crimped spunbonded nonwoven layers.

The spunbonded nonwoven laminate according to the invention is thus quite particularly preferably at least three-layered, in particular three-layered, and has a first crimped spunbonded layer, a reinforcing spunbonded layer preferably thereabove and preferably a second crimped spunbonded layer on top of the reinforcing spunbonded layer. It has been shown that such an at least three-layer, in particular three-layer, laminate with a reinforcing spunbonded nonwoven layer between two crimped spunbonded nonwoven layers solves the technical problem according to the invention in a particularly functionally reliable manner and that in particular a particularly advantageous compromise between longitudinal stiffness, drapability and abrasion resistance can be realized. It is furthermore preferred that the above statements regarding the configuration of the crimped spunbonded nonwoven layer or first crimped spunbonded nonwoven layer also apply to the configuration of the second crimped spunbonded nonwoven layer. Preferably, the first crimped spunbonded nonwoven layer and the second crimped spunbonded nonwoven layer are identical or substantially identical in terms of their configuration. However, the first and second crimped spunbonded nonwoven layers can in principle differ in their configuration and properties. If the spunbonded nonwoven laminate according to the invention according to a preferred embodiment has at least two crimped spunbonded nonwoven layers, it is possible for both crimped spunbonded nonwoven layers to have the same degree of crimping or substantially the same degree of crimping. However, it is also possible that the at least two crimped spunbonded nonwoven layers have a different degree of crimping that is however higher in each case than the degree of crimping of the continuous filaments of the reinforcing spunbonded nonwoven layer.

It is within the scope of the invention that the ratio of the tensile strength of the laminate in the machine direction (MD) to the tensile strength of the laminate transverse to the machine direction (CD) is 1.0 to 2.5, preferably 1.1 to 2.3, more preferably 1.2 to 2.0, particularly preferably 1.3 to 1.9. Expediently the tensile strength of the laminate in the machine direction (MD direction) is at least 8 N/5 cm, in particular at least 10 N/5 cm, preferably at least 15 N/5 cm, preferably at least 17.5 N/5 cm, particularly preferably at least 20 N/5 cm, quite particularly preferably at least 22.5 N/5 cm, for example at least 28 N/5 cm. Further preferably, the tensile strength of the nonwoven fabric transverse to the machine direction (CD direction) is at least 6 N/5 cm, in particular at least 8 N/5 cm, preferably at least 10 N/5 cm, preferably at least 12 N/5 cm, particularly preferably at least 15 N/5 cm. The tensile strength of the nonwoven fabric is determined within the scope of the invention in particular according to the following method: “Determination of tensile strength (based on Edana 20.2-89)”: in N/5 cm; with 50 mm sample width; 100 mm clamping length; 200 mm/min test speed.

A preferred embodiment of the spunbonded nonwoven laminate according to the invention is characterized in that for the laminate in the machine direction (MD) a tensile force of greater than 3.0 N/5 cm, preferably greater than 4.0 N/5 cm, more preferably greater than 4.5 N/5 cm at 5% elongation and/or a tensile force of greater than 5.0 N/5 cm, preferably greater than 6.0 N/5 cm, particularly preferably greater than 7.0 N/5 cm at 10% elongation is obtained. The measurement of the tensile force in the machine direction (MD) at the specified elongation or the stress-strain curve is carried out in particular according to the test standard DIN EN 29073-3. It is within the scope of the invention that a nonwoven sample or a laminate sample with a width of 50 mm is clamped between two clamps with a spacing of 100 mm so that the examined/measured length of the sample is 100 mm. This nonwoven sample or laminate sample is tensioned using a tension machine at a feed rate of 100 mm/min up to a preload of 0.5 N. In this state, the measurement is reset to zero and the actual measurement begins. The tension machine works with a feed or pulling speed of 200 mm/min. The tensile force in the machine direction (MD) is determined as the force at 5% strain of the sample and/or at 10% strain of the sample from the stress-strain curve, as already explained above. The tensile force in the machine direction (MD) is in particular a measure for the longitudinal stiffness of the spunbonded nonwoven laminate.

According to a particularly recommended embodiment of the invention, the spunbonded nonwoven laminate has an embossing pattern consisting of a plurality of preferably not interconnected embossments, wherein the embossments each have an embossing area of 0.05 to 0.3 mm², preferably of 0.06 to 0.2 mm², preferably of 0.07 to 0.18 mm², particularly preferably of 0.08 to 0.15 mm² and quite particularly preferably of 0.09 to 0.12 mm². In the context of the invention, the term “embossing” means in particular a compacted location of the laminate or nonwoven fabric where the laminate has a smaller thickness in comparison to its nonembossed regions and where the fibers of the laminate are at least partially connected or fused to one another, preferably by the action of pressure and/or temperature. The embossments of the embossing pattern are preferably made by a pair of calender rollers with complementary embossing patterns or embossing elements.

In the context of the invention, the term embossing pattern refers in particular to the pattern resulting from the plurality of embossments of the laminate or nonwoven fabric. The embossing pattern can be a regular and/or an irregular embossing pattern. Then the individual embossments are preferably distributed at regular spacings, preferably at identical spacings on the laminate. Further preferably, according to preferred embodiment of the invention, the embossing area of the individual embossments of the embossing pattern are the same size or substantially the same size. It has proven to be beneficial that the geometry of the embossing areas of the individual embossments is identical or substantially identical. Quite particularly preferably, the embossing pattern has the same or the same-size embossments or substantially the same or the same-size embossments with a homogeneous distribution of embossments of the same geometry or of substantially the same geometry. In principle, however, it is also possible that the individual embossments of the embossing pattern have a different size and/or a different geometry and/or that the embossments are in an irregular embossing pattern on the nonwoven fabric. In the context of the invention, “geometry of the embossments” means in particular the geometry of the embossing areas of the embossments in plan view.

In the context of the invention, “the embossing area” of an embossing means in particular the embossed area of an embossment, whereby when determining the size of the embossing area, any material overhang or material projection that may have formed in the course of the pressing or embossing process and that at least partially surrounds the embossment is in particular not part of the embossing area of an embossment. In the case of an embossment or an embossing area with a punctuate or circular geometry in plan view, the embossing area of the embossment corresponds, for example, to the area of the punctuate embossment or circular embossment, wherein the material overhang or the material projection possibly surrounding the embossment is not included in the embossing area of the embossment. The fact that the embossments of the nonwoven fabric according to the invention or laminate each have an embossing area in the above-mentioned region means in particular within the scope of the invention that at least 95%, preferably at least 97% of all the embossments of the nonwoven fabric have an embossing area in the specified region. Particularly preferably all the embossments of the nonwoven fabric have an embossing area in the specified region. Within the scope of the invention, the embossing area of an embossment can be determined in particular by incident light or transmitted light 2D microscopy, and/or by scanning electron microscopy (SEM) and/or by microcomputer tomography (μCT). In the corresponding image evaluation, a geometry that forms the basis of the embossing area geometry or that corresponds or substantially corresponds to the embossing area geometry is preferably used as a basis and is placed over the individual optically imaged embossing areas of the embossments for evaluation.

The preferred embodiment of the spunbonded nonwoven laminate according to the invention with an embossing pattern, in which the embossments each have an embossing area in the previously specified size, is based on the discovery that the spunbonded nonwoven laminate is then characterized by particularly advantageous mechanical properties and that, due to the special size of the embossing areas, a laminate can nevertheless be provided in which optical impairments caused by the embossing pattern of embossments can be almost completely avoided due to a comparatively significantly reduced perceptibility of the embossing pattern for the human eye.

It is within the scope of the invention that the proportion of the total embossing area of the embossing pattern to the total surface area of the laminate is 2 to 12%, preferably 2.5 to 8%, more preferably 3 to 6%, particularly preferably 3.5 to 5.5% and quite particularly 4 to 5%. It is also within the scope of the invention that the proportion of the total embossing area of the embossing pattern to the total surface area of the laminate is less than 10%, preferably less than 8%, preferably less than 7.5%, very preferably less than 6.5%, particularly preferably less than 5.5% and quite particularly preferably less than 5%. As a result of this proportion of the total embossing area of the embossing pattern to the total surface area of the laminate or nonwoven fabric the optical perceptibility of the embossing pattern of embossments can be further reduced. Nevertheless, a laminate with satisfactory mechanical properties results. In this context, the “total embossing area of the embossing pattern” means in particular the sum of all embossing areas of the embossing pattern. “Total surface area of the laminate or nonwoven fabric” means in the context of the invention in particular the entire laminate surface area including the embossed and nonembossed areas.

It is very preferred that the smallest spacing d between two embossments of the embossing pattern is in each case 0.6 to 2.5 mm, preferably 0.8 to 2.0 mm, preferably 0.9 to 1.8 mm, particularly preferably 0.95 to 1.6 mm and quite particularly preferably 1.0 to 1.5 mm. Expediently, the smallest spacing d between two embossments of the embossing pattern is in each case at least 0.6 mm, in particular at least 0.8 mm, preferably at least 1.0 mm, particularly preferably at least 1.4 mm and quite particularly preferably at least 2.0 mm. “The smallest spacing d” between two embossments of the embossing pattern means in particular the smallest spacing d between two immediately adjacent embossments of the embossing pattern, i.e. preferably the smallest spacing between one embossment and the embossment of the embossing pattern that is closest to it. Furthermore, the smallest spacing d between two embossments of the embossing pattern refers in particular to the smallest spacing between the embossing boundaries of two embossments, i.e. to the smallest spacing between the two embossments along the interposed nonembossed area of the nonwoven fabric. This embodiment is based on the discovery that the optical perceptibility of the embossing pattern of embossments can be further reduced, whilst advantageous mechanical properties of the laminate are nevertheless ensured. The previously described smallest spacing of two embossments of the embossing pattern preferably refers to at least 95%, preferably to at least 97% of all the embossments of the laminate. Particularly preferably, the described smallest spacing between two embossments refers to all the embossments of the laminate.

It is recommended that the embossing areas of the embossments in plan view have at least a geometry selected from the group: “punctuate or circular, elliptical, square, rectangular, diamond-shaped, polygonal, linear, wavy.” As has already been described above, “embossing area of an embossing” means in particular the embossed area of an embossment without any material overhang or material projection possibly surrounding the embossing area. It is preferred that the embossing areas or the embossments of the embossing pattern each have the same or substantially the same geometry. In principle, however, it is also within the scope of the invention that the embossing pattern has embossing areas or embossments of different geometries. A particularly preferred embodiment of the invention is characterized in that the embossing areas of the embossments or of all the embossments are punctuate or circular in plan view.

A recommended embodiment of the invention is characterized in that the laminate or the nonwoven fabric has a mass per unit area of less than 200 g/m², in particular less than 150 g/m², preferably less than 100 g/m², preferably less than 75 g/m², particularly preferably less than 50 g/m², and quite particularly preferably less than 30 g/m². It is particularly preferred that the mass per unit area of the laminate is 10 g/m² to 80 g/m², preferably 15 g/m² to 60 g/m², preferably 15 g/m² to 30 g/m². According to another preferred embodiment of the invention, the mass per unit area of the laminate is 11 g/m² to 60 g/m², preferably 12 g/m² to 30 g/m².

It is further preferred that the nonwoven fabric or the laminate has a thickness h of 0.1 to 0.85 mm, preferably of 0.15 to 0.75 mm, preferably of 0.2 to 0.65 mm, particularly preferably of 0.25 to 0.55 mm. It is within the scope of the invention that the nonwoven fabric has a thickness h of less than 0.85 mm, preferably of less than 0.75 mm, particularly preferably of less than 0.65 mm, particularly preferably of less than 0.5 mm, very preferably of less than 0.45 mm, quite particularly preferably of less than 0.4 mm, for example of less than 0.35 mm. “Thickness h” means the greatest thickness or total thickness of the laminate transversely, in particular perpendicularly or substantially perpendicularly to its planar extension in the nonembossed regions of the laminate. The thickness or total thickness h of the nonwoven fabric is measured in particular according to the method WRT 120.6(05)-Option A. In the context of the invention, the thickness h refers in particular to the finished, optionally preconsolidated and/or finally consolidated, laminate.

A very proven embodiment of the invention is characterized in that the laminate has an abrasion resistance of at least Class 2 according to Martindale, preferably Class 1 according to Martindale. This embodiment is based on the discovery that the laminate or nonwoven fabric is then characterized by a very satisfactory abrasion resistance and that, in particular, delamination processes of the laminate during the Martindale test are avoided. The abrasion resistance of the laminate or nonwoven fabric is determined in the context of the invention in particular using a Martindale abrasion tester according to the following test method:

In particular the “SDL Atlas M235 Martindale Tester” is used as the test device. The procedure for determining the abrasion resistance is preferably based on WSP20.5(05), wherein the following deviations from WSP20.5(05) are provided in particular: the surface (top/bottom) is tested separately; at least 10, preferably at least 20 tests are carried out per sample and surface, wherein the test specimens are taken uniformly from the area of the sample, the final result being the arithmetic mean. The test specimens are to be obtained from a representative position, for example not just from the edge, since the test or the deviations in the result should not be influenced by macroscopic deviations, such as poor process control, but only by typical (local) fluctuations; the tested sample is stretched on standard felt and mounted in the lower holder; the same nonwoven fabric is used as the moving upper friction surface with the sides to be tested against each other; this piece is placed together with the PU foam patch (e.g. from SDL Atlas); 9 kPa contact pressure; 32 cycles, i.e. two full rounds of the Lissajous figure; after each of the tests the pair (test specimen and upper friction surface) is exchanged; the samples are rated from 1 to 5, with 1 being the best rating. For example, if the mean is 1 on the top and 3 on the bottom, the sample is rated 1 overall. Only the changes in the nonwoven are evaluated; if the nonwoven previously showed similar defects, these can be overlooked. This means strands of fibers, groups or bundles of fibers on the surface. If a test specimen clearly exhibits these defects from the outset, the test specimen should be excluded in case of doubt.

Grade 1: Virtually no change when viewed from above. The surface may be slightly loosened, but the filaments may only loosen and not form larger or longer clumps. When viewed from the side, the pile height of the loose filaments must not exceed 5 mm. Individual filaments or filaments may be pushed together to form a small ball <2 mm in diameter.

Grade 2: in addition to the above damage pattern (Grade 1): Filaments are loosened and matted with neighboring filaments to form an elongated agglomerate. These groups of filaments are called “strands” or “strings or bundles”. These strands are 5 to 40 mm long and are connected to the substrate at least every 10 mm. A strand is max. 5 mm high (5 mm above the surface) and max. 2 mm wide.

Grade 3: The above “strands” are no longer connected to the substrate along their length, possible connections are >10 mm apart or the strands here are only connected to the specimen at the start and end point. It is possible to lift and move these strands e.g. with a needle.

Grade 4: The strands are connected to neighboring strands to form a network. “Spider web”.

Grade 5: The sample is further destroyed, first hole formation has occurred.

A proven embodiment of the invention is characterized in that the laminate or nonwoven fabric is consolidated with at least one calender roller, in particular of making the previously described embossing pattern that is preferably provided, and preferably with at least one hot-fluid main consolidater, in particular with at least one hot-air main consolidater. The at least one calender roller is preferably part of a calender, which preferably comprises at least two calender rollers or at least one pair of calender rollers. If the laminate is consolidated according to a preferred embodiment with at least one calender roller, in particular of making the embossing pattern, and with at least one hot-fluid main consolidater, the result is in particular a spunbonded nonwoven laminate that is characterized by a further improved mechanical stability and at the same time by an advantageously low flexural stiffness and also preferably by a satisfactory abrasion resistance and further preferably by advantageous optical properties.

To attain this object, the invention further teaches a method of making a spunbonded nonwoven laminate, in particular a previously described spunbonded nonwoven laminate, comprising at least two spunbonded nonwoven layers made of continuous filaments, wherein crimped continuous filaments are made and laid down to form at least one crimped spunbonded nonwoven layer, wherein the crimped continuous filaments of the crimped spunbonded nonwoven layer are multicomponent filaments, in particular bicomponent filaments that have at least one first, preferably low-melting, plastic component and at least one second, preferably higher-melting, plastic component,
wherein noncrimped continuous filaments and/or less crimped continuous filaments compared to the continuous filaments of the at least one crimped spunbonded nonwoven layer are made and laid down to form at least one reinforcing spunbonded nonwoven layer, in particular laid down on top of the at least one crimped spunbonded nonwoven layer, wherein the continuous filaments of the reinforcing spunbonded nonwoven layer have at least one binder component on their surface,
wherein the melting temperature difference between the binder component of the continuous filaments of the reinforcing spunbonded nonwoven layer and the first, preferably low-melting, plastic component of the continuous filaments of the crimped spunbonded nonwoven layer is less than 15° C., preferably less than 12° C., preferably less than 8° C., particularly preferably less than 5° C., very preferably less than 3° C., very particularly preferably less than 2° C., for example 0° C. or about 0° C., and
wherein the laminate has a maximum flexural stiffness with a cantilever of at most 100 mm, preferably of at most 90 mm, preferably of at most 80 mm, particularly preferably of at most 75 mm and quite particularly preferably of at most 70 mm.

In the context of the method according to the invention, it is preferred that crimped continuous filaments are made and deposited to form at least a second crimped spunbonded nonwoven layer, in particular deposited on top of the at least one reinforcing spunbonded nonwoven layer, so that quite particularly preferably an at least three-layer, in particular a three-layer, laminate is obtained, in which the at least one reinforcing spunbonded nonwoven layer forms the middle layer.

It is particularly preferred that the laminate is consolidated or finally consolidated with at least one calender roller and wherein an embossing pattern comprising a plurality of embossments is preferably introduced into the laminate by the at least one calender roller, wherein the embossments preferably each have an embossing area of 0.05 to 0.3 mm², preferably of 0.06 to 0.2 mm², preferably of 0.07 to 0.18 mm², particularly preferably of 0.08 to 0.15 mm² and most preferably of 0.09 to 0.12 mm².

It is within the scope of the method according to the invention that the laminate or the nonwoven fabric, preferably following consolidation with the at least one calender roller, in particular with at least one calender comprising the calender roller or pair of calender rollers, is consolidated, in particular main-consolidated, with at least one hot-fluid main consolidater, in particular with at least one hot-air main consolidater. According to a further preferred embodiment of the method according to the invention, the laminate, after being deposited on a receiving device, in particular on a foraminous belt, is first preconsolidated with at least one preconsolidater, in particular with at least one hot-fluid preconsolidater, preferably with at least one hot-air preconsolidater, preferably then consolidated with the at least one calender roller and subsequently preferably consolidated with a hot-fluid main consolidater or hot-air main consolidater, in particular main-consolidated. In the context of the invention, “preconsolidation” means in particular a consolidation of the laminate or of a layer of the laminate that ensures the transportability, but preferably leads to a lower degree of consolidation of the laminate than a consolidation or main consolidation.

It is within the scope of the invention that the at least one crimped spunbonded nonwoven layer, preferably the at least two crimped spunbonded nonwoven layers, and the at least one reinforcing spunbonded nonwoven layer are made according to the spunbond process or as spunbonded layers. For this purpose, the continuous filaments are first spun from a spinning head or a spinneret. The spun continuous filaments are then expediently cooled in a cooling chamber and stretched in a stretcher. The cooling and stretching takes place in particular in a combined cooler and stretcher. It is recommended that the stretching of the continuous filaments takes place as aerodynamic stretching. It is within the scope of the invention that the subassembly comprising the cooling chamber and the stretcher or the combined cooling and stretching subassembly, apart from the air supply in the cooling chamber or cooling subassembly—is a closed system. This means that in this subassembly, in addition to the air supply in the cooling chamber or cooling subassembly, no further air supply takes place. This embodiment of the closed system has proven particularly suitable for the production of a laminate according to the invention. According to a preferred embodiment of the invention, the cooled and stretched continuous filaments for the spunbonded nonwoven layers of the spunbonded nonwoven laminate are guided through at least one diffuser and subsequently deposited on a receiving device, in particular on a foraminous belt. Expediently, firstly the continuous filaments for the (first) crimped spunbonded nonwoven layer, then the continuous filaments for the reinforcing spunbonded nonwoven layer and, according to a preferred embodiment, subsequently the continuous filaments for the second crimped spunbonded nonwoven layer are deposited on the receiving device or on the foraminous belt. In principle, other sequences of production and deposition of the individual spunbonded nonwoven layers and thus other layer structures of the resulting laminate are also possible.

The invention is based on the discovery that the spunbonded nonwoven laminate according to the invention is characterized by an optimal compromise between mechanical stability, in particular a sufficient longitudinal stiffness, a satisfactory drapability, in particular an advantageously low flexural stiffness, and nevertheless a sufficient abrasion resistance. Delamination processes can be largely avoided in the spunbonded nonwoven laminate according to the invention. In the spunbonded nonwoven laminate according to the invention, the at least one crimped spunbonded nonwoven layer is particularly responsible for the advantageous drapability and low flexural stiffness. The at least one reinforcing spunbonded nonwoven layer contributes primarily to the fact that the spunbonded nonwoven laminate is characterized by an advantageous mechanical stability, in particular by a satisfactory longitudinal stiffness. In addition, the reinforcing spunbonded nonwoven layer or the adjustment of the components of the filaments of the reinforcing spunbonded nonwoven layer and the at least one crimped spunbonded nonwoven layer advantageously contributes to the fact that delamination processes in the spunbonded nonwoven laminate are avoided and that a further improved abrasion resistance of the spunbonded nonwoven laminate is obtained. If, according to a preferred embodiment of the spunbonded nonwoven laminate according to the invention or the method according to the invention, an embossing pattern consisting of a plurality of embossments with the specific embossing area size is provided, this further contributes to an advantageous mechanical stability of the spunbonded nonwoven laminate, whereby optical impairments of the spunbonded nonwoven laminate by the embossing pattern are almost completely avoided. It should also be emphasized that the advantages according to the invention are achieved with not very complex measures, so that the spunbonded nonwoven laminate according to the invention and also the method according to the invention of making such a spunbonded nonwoven laminate are also characterized by advantageous economic efficiency.

The invention is explained in more detail hereinafter using an exemplary embodiment that represents only a preferred embodiment of the invention. Within the scope of the invention and here, a spunbonded nonwoven laminate according to the invention is made from three spunbonded nonwoven layers by a three-beam system. The three spunbonded nonwoven layers are made in particular using the spunbond process. Expediently the three spunbonded nonwoven layers are made using the Reicofil method, whereby the filaments spun for a spunbonded nonwoven layer are first passed through a cooling chamber, and are cooled there with cooling air and then introduced into a stretcher for aerodynamic stretching. Expediently and here, during production each spunbonded nonwoven layer is processed using a combined cooling and stretching subassembly that is a closed unit. This means that in this cooling and stretching subassembly, apart from the air supply in the cooling chamber, there is no further air supply from outside. After passing through the stretcher, the filaments of each spunbonded nonwoven layer are passed through a diffuser and then deposited on a foraminous belt to form the spunbonded nonwoven layer.

Within the scope of the invention and here, a lower (first) crimped spunbonded nonwoven layer consists of crimped continuous filaments with eccentric core-sheath configuration. The first, here preferably low-melting, plastic component of the continuous filaments expediently forms the sheath component in this embodiment and preferably consists substantially of a polypropylene copolymer (Basell RP248R). The second, preferably and here, higher melting, plastic component of the continuous filaments of the (first) lower crimped spunbonded nonwoven layer preferably and here forms the core component and expediently substantially consists of a homo-polypropylene (Exxon PP3155E5) that preferably and here was polymerized by Ziegler-Natta catalysis.

The continuous filaments of the reinforcing spunbonded nonwoven layer that expediently and here forms a middle layer of the three-layer spunbonded nonwoven laminate, are preferably and here monocomponent filaments. These monocomponent filaments preferably and here, substantially consist of a binder component or of a first plastic, and this first plastic expediently and here comprises a homo-polypropylene that has been polymerized by metallocene catalysis (Atofina MR2001). The monocomponent filaments are noncrimping.

For the upper second crimped spunbonded nonwoven layer, preferably and here, the same data as for the first lower crimped spunbonded nonwoven layer described above apply. In the resulting three-layer laminate, a melting temperature difference between the binder component of the continuous filaments of the reinforcing spunbonded nonwoven layer and the first, preferably and here, low-melting, plastic component of the continuous filaments of the crimped spunbonded nonwoven layers of less than 3° C. results, wherein the binder component of the continuous filaments of the reinforcing spunbonded nonwoven layer expediently has a higher melting temperature than the first plastic component of the continuous filaments of the crimped spunbonded nonwoven layers. Furthermore, the resulting spunbonded nonwoven laminate expediently and here has a cantilever in the MD direction of 41 mm. For the spunbonded nonwoven laminate, preferably and here a tensile force in the machine direction (MD) of 6.4 N/5 cm at 5% elongation and 10.0 N/5 cm at 10% elongation is obtained.

The invention is explained in more detail hereinafter with reference to a drawing that merely represents an exemplary embodiment. In the figures in schematic representation:

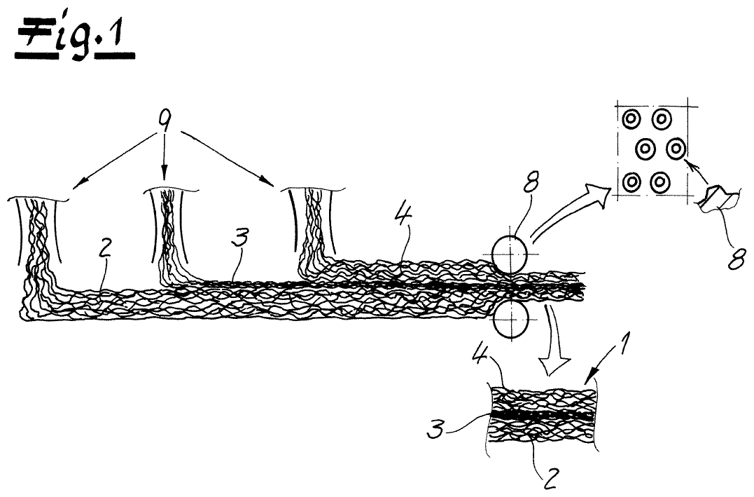

FIG. 1 is a side view of a spunbonded nonwoven laminate according to the invention and an apparatus for making a spunbonded nonwoven laminate according to the invention,

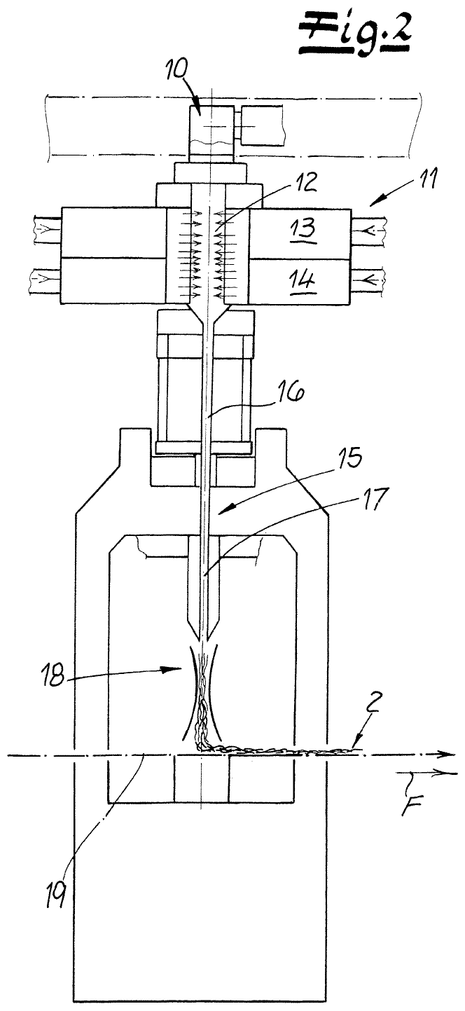

FIG. 2 is a vertical section through a part of the device according to FIG. 1,

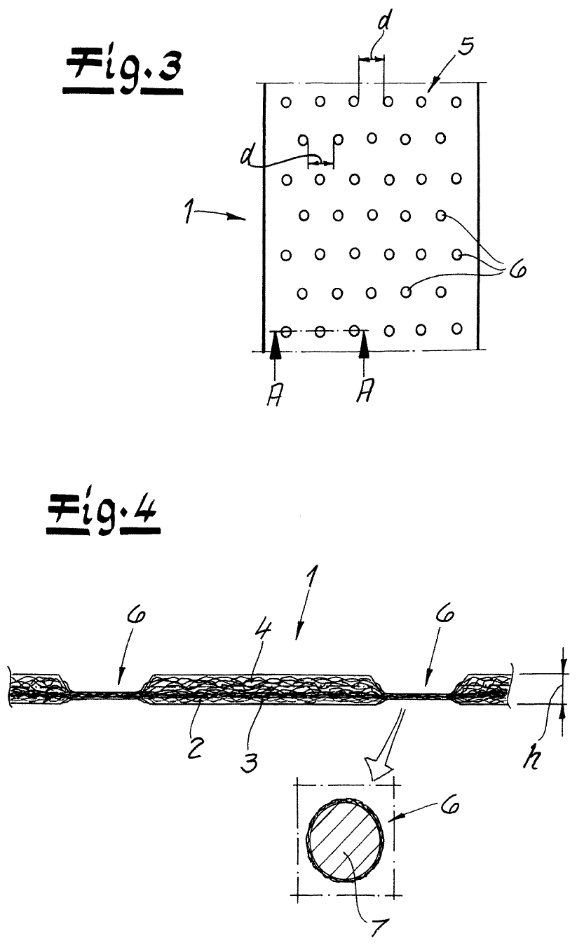

FIG. 3 is a plan view of a spunbonded nonwoven laminate according to the invention, and

FIG. 4 is a cross-section along line A of FIG. 3.

Preferably and here, a spunbonded nonwoven laminate 1 with at least three spunbonded nonwoven layers 2, 3, 4 made of continuous filaments can be made using the apparatus shown in FIG. 1 or using the method according to the invention. Preferably and here, the spunbonded nonwoven laminate 1 consists of only three spunbonded nonwoven layers 2, 3, 4, and preferably and here, these comprise a first lower crimped spunbonded nonwoven layer 2, a reinforcing spunbonded nonwoven layer 3 a middle layer and a second upper crimped spunbonded nonwoven layer 4. The continuous filaments expediently and here consist of thermoplastic material.

Preferably and here according to FIG. 1, the spunbonded nonwoven laminate 1 has a first lower crimped spunbonded nonwoven layer 2 and a second upper crimped spunbonded nonwoven layer 4, each consisting or substantially consisting of crimped continuous filaments. The crimped continuous filaments of the crimped spunbonded nonwoven layers 2, 4 preferably and here may have an eccentric core-sheath configuration. Preferably, the core consists or substantially consists of a homo-polypropylene and the sheath expediently and here, consists or substantially consists of a polypropylene copolymer.

Preferably and here, the spunbonded nonwoven laminate 1 further comprises a reinforcing spunbonded nonwoven layer 3 between the two crimped spunbonded nonwoven layers 2, 4. The reinforcing spunbonded nonwoven layer 3 preferably consists of noncrimped continuous filaments and expediently and here, the noncrimped continuous filaments of the reinforcing spunbonded nonwoven layer 3 have a centric or symmetrical core-sheath configuration, wherein the sheath of the continuous filaments of the reinforcing spunbonded nonwoven layer 3 is formed by a binder component that consists or substantially consists of a first plastic and this plastic expediently and here comprises a polypropylene copolymer and quite particularly preferably the same polypropylene copolymer that forms the sheath component of the continuous filaments of the crimped spunbonded nonwoven layers 2, 4. The core component of the continuous filaments of the reinforcing spunbonded nonwoven layer 3 preferably and here consists or substantially consists of a homo-polypropylene that has been polymerized by metallocene catalysis.

To make the spunbonded nonwoven laminate 1 preferably and here, the continuous filaments of the first lower crimped spunbonded nonwoven layer 2 are first made and deposited on a receiving device not shown in detail in FIG. 1 and optionally compacted or preconsolidated. Subsequently, the noncrimped continuous filaments of the reinforcing spunbonded nonwoven layer 3 are preferably made and preferably and here are deposited on top of the first lower crimped spunbonded nonwoven layer 2 and optionally compacted or preconsolidated. Subsequently, the crimped continuous filaments of the second upper crimped spunbonded nonwoven layer 4 are preferably made and preferably and here laid on top of the reinforcing spunbonded nonwoven layer 3 and optionally compacted or preconsolidated. The individual devices for compacting or preconsolidation are not shown in detail in FIG. 1.

The aggregate consisting of the two crimped spunbonded nonwoven layers 2, 4 and the reinforcing spunbonded nonwoven layer 3 is then finally consolidated using a calender with at least one calender roller 8, preferably and here with a pair of calender rollers. It is within the scope of the invention that the preferably provided embossing pattern 5 comprising a plurality of embossments 6 is introduced into the laminate 1 with the calender roller 8. This will be explained in more detail hereinafter. The second calender roller is preferably configured to be smooth or has a smooth surface.

In FIG. 1, three apparatuses 9 for making a spunbonded nonwoven layer are schematically indicated and this is a three-beam system with three spinning beams. FIG. 2 shows the basic structure of an apparatus 9 of making a spunbonded nonwoven layer, for example a crimped spunbonded nonwoven layer 2 according to the spunbond process, comprising a spinneret or the spinning beam 10 for spinning the continuous filaments for the spunbond spunbonded nonwoven layer. The continuous filaments spun by the spinneret or spinning beam 10 are introduced into a cooler 11 with a cooling chamber 12. Preferably and here, air supply cabins 13, 14 one above the other are provided on two opposite sides of the cooling chamber 12. Air at different temperatures is preferably introduced into the cooling chamber 12 from the air supply cabins 13, 14 one above the other.

It is recommended here that a stretcher 15 for stretching the continuous filaments is provided downstream of the cooler 11 in the filament-travel direction. Expediently and here, the stretcher 15 has an intermediate passage 16 that connects the cooler 11 with a stretching shaft 17 of the stretcher 15. Preferably and here, the subassembly comprising the cooler 11, the intermediate passage 16 and the stretching shaft 17 is a closed unit and apart from the supply of cooling air in the cooler 11, flow of air from the outside into this subassembly is blocked.

Expediently and here, a diffuser 18 through which the continuous filaments are guided adjoins the stretcher 15 in the filament-travel direction. After passing through the diffuser 18, the continuous filaments preferably and here are deposited on a receiving device formed as a foraminous belt 19. The foraminous belt 19 preferably and here is an endlessly rotating foraminous belt 19. It is within the scope of the invention that the foraminous belt 19 is permeable to air, so that suction of process air from below through the foraminous belt is possible. FIG. 2 also shows the travel direction F of the spunbonded nonwoven layer 2 or the laminate and the foraminous belt 19 and thus the machine direction (MD).

FIGS. 3 and 4 show a laminate 1 according to the invention with the spunbonded nonwoven layers 2, 3 and 4. The laminate 1 preferably and here has an embossing pattern 5 consisting of a plurality of embossments 6 that are not connected to one another. “Embossment” means in particular a compacted location of the laminate 1 where the laminate 1 has a smaller thickness compared to the nonembossed regions and where the continuous filaments of the laminate 1 are at least partially connected or fused to one another, preferably by the action of pressure and/or temperature. The embossing pattern 5 preferably and here is a regular embossing pattern 5, whose individual embossments 6 are preferably and here distributed at regular spacings on the laminate 1 or on the nonwoven fabric.

Expediently and here, the embossments 6 each have an area 7 of 0.05 to 0.3 mm². “Embossing area 7 of an embossment 6” means, within the scope of the invention and here, in particular the embossed area of an embossment 6, wherein when determining the size of the embossing area 7, the material overhang or material projection possibly formed in the course of the pressing or embossing process and at least partially surrounding the embossment 6 is not part of the embossing area 7 of an embossment 6. This can be seen particularly in FIG. 4 in the hatched representation. Further preferably and here, the embossing area 7 of the individual embossments 6 of the embossing pattern 5 is the same size or substantially the same size. Preferably and here, the embossing areas 7 of the embossments 6 have a punctuate or circular geometry in plan view.

Within the scope of the invention, the smallest spacing d between two embossments 6 of the embossing pattern 5 is in each case 0.6 to 2.5 mm. “The smallest spacing d between two embossments 6” means in particular the smallest spacing d between two immediately adjacent embossments 6 of the embossing pattern 5, thus preferably the smallest spacing d between an embossment 6 and the embossment 6 of the embossing pattern 5 that is closest to it. Furthermore, the smallest spacing d between two embossments 6 refers in particular to the smallest spacing d between the embossing boundaries of two embossments 6, i.e. to the smallest spacing between the two embossments 6 along the interposed nonembossed area of the spunbonded nonwoven laminate 1 or the nonwoven fabric (FIG. 3).

Expediently the thickness h of the spunbonded nonwoven laminate 1 is 0.15 to 0.75 mm. In this embodiment according to the figures, the thickness h of the laminate 1 may be approximately 0.3 mm. “Thickness h” means the greatest thickness or total thickness of the spunbonded nonwoven laminate 1 transversely, in particular perpendicularly or substantially perpendicularly to its planar extension in the nonembossed regions of the laminate 1. This can be seen particularly in FIG. 4. In the context of the invention, the thickness h refers in particular to the finished, optionally preconsolidated and/or finally consolidated, laminate 1.

1. In a spunbonded nonwoven laminate having at least two spunbonded nonwoven layers made of continuous filaments including at least one crimped spunbonded nonwoven layer that has crimped continuous filaments, the improvement wherein
the crimped continuous filaments of the at least one crimped spunbonded nonwoven layer are multicomponent filaments that comprise at least one first low-melting, plastic component and at least one second higher-melting, plastic component,
at least one reinforcing spunbonded nonwoven layer is provided that consists of or substantially consists of noncrimped continuous filaments and/or of continuous filaments that are less crimped compared to the continuous filaments of the at least one crimped spunbonded nonwoven layer, the continuous filaments of the reinforcing spunbonded nonwoven layer comprising at least one binder component on their surface,
a melting temperature difference between the binder component of the continuous filaments of the reinforcing spunbonded nonwoven layer and the first low-melting, plastic component of the continuous filaments of the at least one crimped spunbonded nonwoven layer is less than 15° C., and
the laminate has a maximum flexural stiffness with a cantilever of at most 100 mm.

2. The spunbonded nonwoven laminate according to claim 1, wherein the laminate has a maximum flexural stiffness with a cantilever of at most 65 mm.

3. The spunbonded nonwoven laminate according to claim 1, wherein the continuous filaments of the at least one reinforcing spunbonded nonwoven layer are monocomponent filaments that consist of or substantially consist of the binder component.

4. The spunbonded nonwoven laminate according to claim 1, wherein the continuous filaments of the at least one reinforcing spunbonded nonwoven layer are multicomponent filaments with centric or symmetrical core-sheath configuration or with eccentric core-sheath configuration, and the at least one binder component of the continuous filaments of the reinforcing spunbonded nonwoven layer forms the sheath component of the continuous filaments with core-sheath configuration.

5. The spunbonded nonwoven laminate according to claim 4, wherein a core-to-sheath mass ratio of the continuous filaments of the reinforcing spunbonded nonwoven layer with core-sheath configuration is 50:50 to 95:5.

6. The spunbonded nonwoven laminate according to claim 1, wherein the melting temperature of the binder component of the continuous filaments of the reinforcing spunbonded nonwoven layer is lower than the melting temperature of the second higher-melting, plastic component of the continuous filaments of the at least one crimped spunbonded nonwoven layer.

7. The spunbonded nonwoven laminate according to claim 1, wherein the continuous filaments of the at least one reinforcing spunbonded nonwoven layer are more strongly oriented in the machine direction than the continuous filaments of the at least one crimped spunbonded nonwoven layer.

8. The spunbonded nonwoven laminate according to claim 1, wherein the titre of the continuous filaments of the at least one reinforcing spunbonded nonwoven layer is less than 2.5 den or the titre of the continuous filaments of the at least one crimped spunbonded nonwoven layer is less than 3.0den.

9. The spunbonded nonwoven laminate according to claim 1, wherein the at least one binder component of the continuous filaments of the reinforcing spunbonded nonwoven layer comprises a first plastic that is a homo-polyolefin or a polyolefin copolymer.

10. The spunbonded nonwoven laminate according to claim 1, wherein the at least one binder component of the reinforcing spunbonded nonwoven layer consists of or substantially consists of a mixture or a blend of at least a first plastic and at least a second plastic.

11. The spunbonded nonwoven laminate according to claim 1, wherein the first or the second plastic component of the continuous filaments of the at least one crimped spunbonded nonwoven layer is at least one homo-polyolefin or at least one polyolefin copolymer.

12. The spunbonded nonwoven laminate according to claim 1, wherein the binder component of the continuous filaments of the reinforcing spunbonded nonwoven layer and/or the first low-melting, plastic component of the continuous filaments of the at least one crimped spunbonded nonwoven layer or the second higher-melting plastic component of the continuous filaments of the at least one crimped spunbonded nonwoven layer are each formed on the basis of a polyolefin from the same polyolefin material.

13. The spunbonded nonwoven laminate according to claim 1, wherein the continuous filaments of the at least one crimped spunbonded nonwoven layer are multicomponent filaments with side-by-side configuration and/or with core-sheath configuration, and the first preferably low-melting plastic component of the continuous filaments of the at least one crimped spunbonded nonwoven layer forms the sheath component.

14. The spunbonded nonwoven laminate according to claim 1, wherein a mass ratio of the first low-melting, plastic component of the continuous filaments of the at least one crimped spunbonded nonwoven layer to the second higher-melting, plastic component of the at least one crimped spunbonded nonwoven layer is 10:90 to 60:40.

15. The spunbonded nonwoven laminate according to claim 1, further comprising:
at least one second crimped spunbonded nonwoven layer, the at least one reinforcing spunbonded nonwoven layer being between the first and second crimped spunbonded nonwoven layers

16. The spunbonded nonwoven laminate according to claim 1, wherein the ratio of the tensile strength of the laminate in the machine direction to the tensile strength of the laminate transverse to the machine direction is 1.0 to 2.5

17. The spunbonded nonwoven laminate according to claim 1, wherein for the laminate in the machine direction a tensile force of greater than 3.0 N/5 cm at 5% elongation or a tensile force of greater than 5.0 N/5 cm at 10% elongation is obtained.

18. The spunbonded nonwoven laminate according to claim 1, wherein the laminate has an embossing pattern consisting of a plurality of embossments each having an embossing area of 0.05 to 0.3 mm².

19. The spunbonded nonwoven laminate according to claim 1, wherein a proportion of the total embossing area of the embossing pattern to the total surface area of the laminate is 2 to 12%.

20. The spunbonded nonwoven laminate according to claim 1, wherein a smallest spacing d between two embossments of the embossing pattern is in each case 0.6 to 2.5 mm.

21. The spunbonded nonwoven laminate according to claim 1, wherein the laminate has an abrasion resistance of at least Class 2 or Class 1 according to Martindale.

22. A method of making a spunbonded nonwoven laminate according to claim 1 and comprising at least two spunbonded nonwoven layers made of continuous filaments, the method comprising the steps of:
making and laying down crimped continuous filaments to form at least one crimped spunbonded nonwoven layer, the crimped continuous filaments of the crimped spunbonded nonwoven layer are multicomponent filaments that comprise at least one first low-melting, plastic component and at least one second higher-melting, plastic component,
making and laying down noncrimped continuous filaments and/or less crimped continuous filaments compared to the continuous filaments of the at least one crimped spunbonded nonwoven layer to form at least one reinforcing spunbonded nonwoven layer, the continuous filaments of the reinforcing spunbonded nonwoven layer having at least one binder component on their surface,
setting the melting temperature difference between the binder component of the continuous filaments of the reinforcing spunbonded nonwoven layer and the first low-melting plastic component of the continuous filaments of the crimped spunbonded nonwoven layer being less than 15° C., and
thereby imparting to the laminate a maximum flexural stiffness with a cantilever of at most 100 mm.

23. The method according to claim 22, further comprising the step of:
making and depositing crimped continuous filaments to form at least a second crimped spunbonded nonwoven layer on top of the at least one reinforcing spunbonded nonwoven layer so that a three-layered, laminate results in which the at least one reinforcing spunbonded nonwoven layer forms the middle layer.

24. The method according to claim 22, further comprising the step of:
consolidating the laminate with at least one calender roller and
thereby introducing in to the laminate an embossing pattern comprising a plurality of embossments by the at least one calender roller such that the embossments each have an embossing area of 0.05 to 0.3 mm².
